(19) United States
(12) Patent Application Publication
(10) Pub. No.: US 2025/0138887 A1
(43) Pub. Date: May 1, 2025

(54) MACHINE LEARNING-BASED DEVICE PROVISIONING MANAGEMENT IN AN INFORMATION PROCESSING SYSTEM

(71) Applicant: Dell Products L.P., Round Rock, TX (US)

(72) Inventors: Lakshmi Saroja Nalam, Bangalore (IN); Vasanth Sathyanarayanan, Bangalore (IN); Parminder Singh Sethi, Ludhiana (IN)

(21) Appl. No.: 18/494,961

(22) Filed: Oct. 26, 2023

(51) Int. Cl. G06F 9/50

(52) U.S. Cl. CPC G06F 9/5027

(57) ABSTRACT

A method utilizes a machine learning algorithm comprising one or more first decision trees generated based on device data representing a set of one or more physical devices in an information processing system to determine a recommendation for adding one or more additional physical devices to the information processing system based on a given system goal. In response to the recommendation, the method utilizes the machine learning algorithm comprising one or more second decision trees generated based on information processing system data to determine one or more hardware profiles for the one or more additional physical devices in accordance with the given system goal. The one or more hardware profiles are deployed to the one or more additional physical devices to enable the one or more additional physical devices to operate in the information processing system with the set of one or more physical devices.

### FIELD

The field relates generally to information processing systems, and more particularly to management techniques for provisioning devices in such information processing systems.

### BACKGROUND

In a typical communication service provider (CSP) network, also referred to as a telecommunications (telco) network (which are examples of what is referred to herein, more generally, as an information processing system or an information processing system environment), hundreds to thousands of devices (e.g., compute devices, edge devices, and cloud devices) are deployed to provide telecommunication services, media, content, entertainment, and/or application services over the network. With the availability of 5G, i.e., the fifth-generation technology standard for cellular networks, it is evident that this number has increased in recent times, and it will increase in the near future when more smart cities, smart homes, autonomous cars, smart factories, and the like, are enabled. It is realized that provisioning such a large number of devices in the CSP network (e.g., enabling the devices to operate or otherwise function in the CSP network) is complex and thus presents significant technical challenges.

### SUMMARY

Illustrative embodiments provide techniques comprising machine learning-based device provisioning management in information processing systems.

For example, in one or more illustrative embodiments, a method comprises utilizing a machine learning algorithm comprising one or more first decision trees generated based on device data representing a set of one or more physical devices in an information processing system to determine a recommendation for adding one or more additional physical devices to the information processing system based on a given system goal. The method further comprises, in response to a recommendation for adding one or more additional physical devices, utilizing the machine learning algorithm comprising one or more second decision trees generated based on information processing system data to determine one or more hardware profiles for the one or more additional physical devices in accordance with the given system goal. The method further comprises deploying the one or more hardware profiles to the one or more additional physical devices to enable the one or more additional physical devices to operate in the information processing system with the set of one or more physical devices.

Advantageously, illustrative embodiments provide a machine learning-based framework and workflow configured to dynamically create and/or modify hardware profiles considering a particular goal (e.g., outcome/solution), and configuration and capacity features of devices in the information processing system (e.g., a communication service provider network or a telecommunications network).

These and other illustrative embodiments include, without limitation, methods, apparatus, networks, systems and processor-readable storage media.

### BRIEF DESCRIPTION OF THE DRAWINGS

FIG. 1 illustrates an information processing system environment configured with machine learning-based device provisioning management functionalities according to an illustrative embodiment.

FIG. 2 illustrates a process flow for machine learning-based device provisioning management according to an illustrative embodiment.

FIG. 3 illustrates a machine learning-based device provisioning management methodology according to an illustrative embodiment.

FIGS. 4 and 5 illustrate examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, processing systems comprising compute, storage and/or network resources, other types of processing systems comprising various combinations of physical and/or virtual resources, as well as other types of distributed computer networks.

As mentioned, as the number of devices in a given information processing system, such as a CSP or a telco network, grows, managing them becomes more complex. It is realized herein that a physical (bare metal) device orchestration platform can be used to address the complexity by enabling CSPs to remotely deploy thousands of devices that are distributed in different locations. For example, Bare Metal Orchestrator from Dell Technologies is an example of such an orchestration platform, wherein CSPs can efficiently provision the devices using hardware profiles (e.g., a declarative model). A hardware profile can be created that contains the instructions to deploy a device or update the current configuration or firmware of an already provisioned device in the CSP network. As illustratively used herein, a device may broadly refer to a bare metal server (such as a physical server), one or more distinct physical pieces of hardware (i.e., components of a server such as, but not limited to, storage drives, processors, memory, switches, etc.). While some illustrative embodiments refer to bare metal servers or components thereof, it is to be appreciated that alternative embodiments may be implemented with any type of physical device wherein provisioning of such devices in an information processing system can present technical challenges.

Assume, by way of example, that a CSP network contains thousands of servers (e.g., as part of a so-called smart city), wherein, as requirements increased, the CSP added more bare metal servers to the network and provisioned the servers with a standard configuration using existing hardware profiles. However, it is realized herein that the addition of bare metal servers with the standard set of configurations may or may not adequately serve an operational or otherwise functional goal (e.g., an outcome or solution providing one or more of efficiency, security, performance, reliability, scalability, agility, etc., which can be measurable in a quantifiable manner) of the network because the standard configuration instructions in the hardware profiles were not developed considering the overall goal of the servers in the CSP network and an expected outcome or solution.

For example, assume that the initial CSP network is configured to perform 50,000 input-output operations per second (IOPS). IOPS is a performance metric used to characterize devices such as, but not limited to, hard disk drives, solid state drives, storage area networks, etc., that are implemented as part of the bare metal servers of a CSP network. Assume now that increased requirements, due to peak user demand, dictate adding additional servers with storage to increase IOPS to 60,000. It is realized herein that using the standard configuration for the new servers and their associated drivers may not necessarily increase the IOPS metric because there is no consideration during provisioning of the additional servers with respect to the existing servers in the network and an overall goal (e.g., outcome/solution) perspective of the network.

Illustrative embodiments overcome the above and other technical challenges by providing a machine learning-based framework and workflow configured to dynamically create and/or modify hardware profiles considering the required goal (e.g., outcome/solution), and the configuration and capacity of other servers in the network.

More particularly, in some illustrative embodiments, a device orchestration platform collects device data of each device in a CSP network. Once the device data is collected, in one or more illustrative embodiments as will be explained, the device data is decomposed into a resolution tree using a gradient boosting algorithm, and used to recommend one or more additional devices to meet the overall goal (e.g., service or solution requirement). Each device is dispatched and deployed on the CSP network based on the recommendation. Once the device is deployed on the CSP network, CSP network data, such as, but not limited to, environment factors, memory requirements, performance data, etc., is collected and decomposed into another resolution tree using a gradient boosting algorithm to determine and deploy the hardware profile for the new device that is needed to meet the CSP network solution requirements (e.g., goal).

In one or more illustrative embodiments, the gradient boosting algorithm can be implemented with a gradient boosting machine (GBM) or a gradient boosting decision tree (GBDT) framework, also referred to as a gradient boosting regression or resolution tree (GBRT) framework. One non-limiting example of such a GBDT framework that can be utilized is XGBoost (extreme gradient boost) which is an optimized distributed gradient boosting framework providing a parallel tree boosting methodology that solves data science problems in a fast and accurate way. However, it is to be understood that embodiments are not intended to be limited to any specific machine learning-based gradient boosting approach.

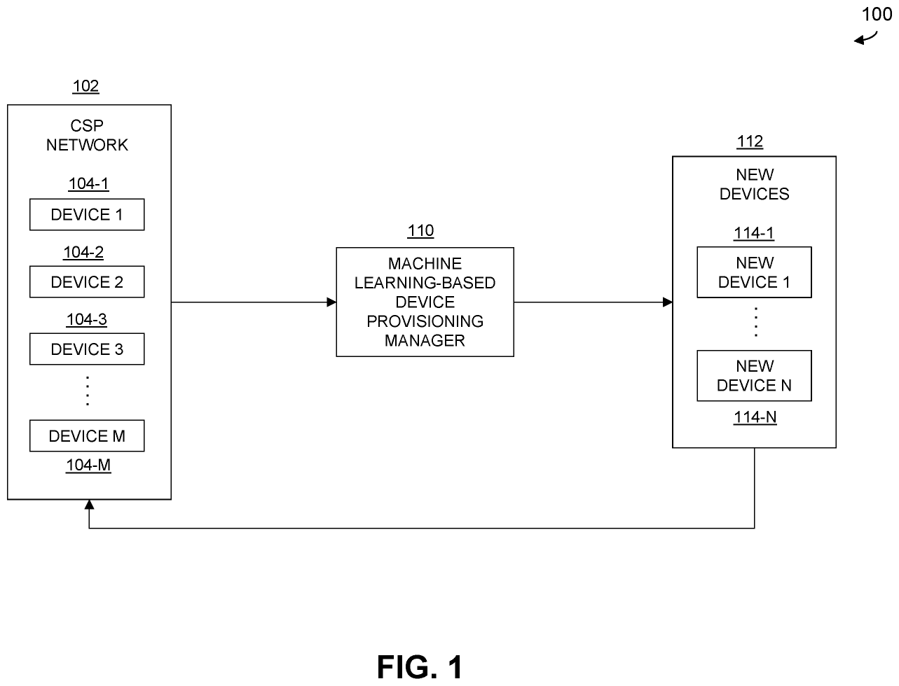

Referring now to FIG. 1, an information processing system environment 100 configured with device provisioning management functionalities is depicted according to an illustrative embodiment. As generally shown, information processing system environment 100 comprises a CSP network 102 comprising a plurality of devices 104-1, 104-2, 104-3, . . . , 104-M (collectively referred to herein as devices 104 or individually as device 104). Each device 104 can be any physical device that is provisioned on CSP network 102 (e.g., server, server component, etc.).

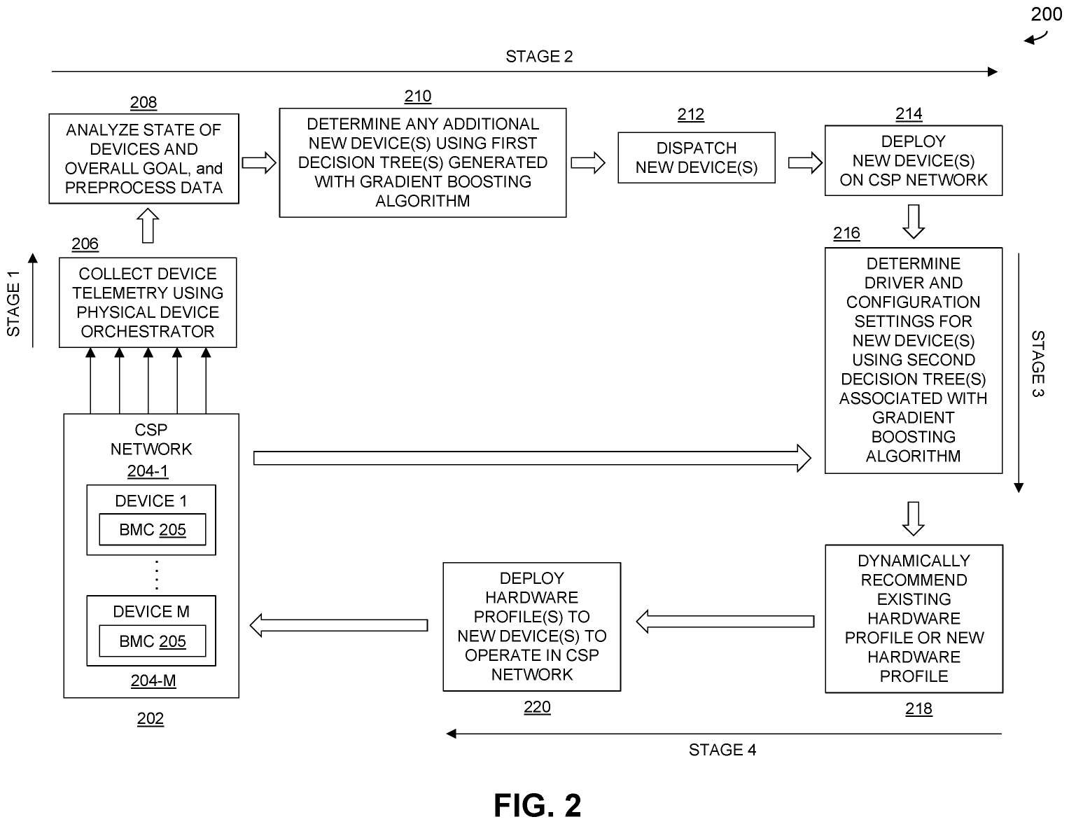

Information processing system environment 100 further comprises, as shown, a machine learning-based device provisioning manager 110 operatively coupled to CSP network 102. As will be further explained in an illustrative embodiment in the context of FIG. 2, machine learning-based device provisioning manager 110 collects device data from devices 104 of CSP network 102 and applies a gradient boosting algorithm to recommend one or more additional devices, e.g., as shown, one or more of new devices 112 comprising a plurality of new devices 114-1, . . . , 114-N (collectively referred to herein as new devices 114 or individually as new device 114) to meet an overall goal (e.g., service or solution requirement) of CSP network 102.

Each new device 114 is dispatched and deployed on CSP network 102 based on the recommendation. Once the new device 114 is deployed on CSP network 102, CSP network data is collected and decomposed into another resolution tree using a gradient boosting algorithm to determine and deploy the hardware profile for new device 114 that is needed to meet the overall goal of CSP network 102.

Referring now to FIG. 2, a process flow 200 for device provisioning management is depicted according to an illustrative embodiment. By way of example, process flow 200 can be implemented by machine learning-based device provisioning manager 110 of FIG. 1.

Process flow 200 operates in accordance with a CSP network 202 comprising a plurality of devices 204-1, . . . , 204-M (collectively referred to herein as devices 204 or individually as device 204). Each device 204 can be any physical device that is provisioned on CSP network 202 (e.g., server, server component, etc.). Further, as shown, each device 204 comprises its own baseboard management controller (BMC) 205. A BMC, as illustratively referred to herein, is a specialized service processor, usually within the motherboard or the main circuit board of a device, that monitors the physical state of the device using sensors, and typically communicates device data to a system administrator and/or automated system through an independent connection, e.g., an intelligent platform management interface (IPMI).

As generally shown, process flow 200 comprises multiple stages wherein: stage 1 comprises step 206; stage 2 comprises steps 208, 210, 212 and 214; stage 3 comprises step 216; and step 4 comprises steps 218 and 220. In general, but as will be explained in further detail below: stage 1 gathers device telemetry from CSP network 202; stage 2 analyzes the state of devices 204 and the over goal of CSP network 202 (e.g., a change from 50,000 IOPS to 60,000 IOPS), provides a recommendation for one or more additional new devices based on the device states and the overall goal; and dispatches/deploys the one or more additional devices to CSP network 202; stage 3 provides a recommendation for one or more drivers and configuration settings for each additional new device; and stage 4 dynamically creates or chooses a hardware profile for each additional new device and deploys the hardware profile to the corresponding additional new device to complete provisioning thereof.

Referring now to step 206, device telemetry is collected from devices 204 of CSP network 202. By way of example, in some illustrative embodiments, a physical device orchestrator (e.g., Bare Metal Orchestrator from Dell Technologies) can be used to collect device data and other data from CSP network 202. For example, BMC 205 of each device 204 can provide device data to the physical device orchestrator in step 206. Note that, in some illustrative embodiments, the physical device orchestrator can be part of or separate from (or some combination thereof) machine learning-based device provisioning manager 110.

Step 208 then analyzes the state of the devices based on the collected device data and an overall goal of CSP network 202. Recall that the overall goal can be an operational or otherwise functional goal (e.g., an outcome or solution providing one or more of efficiency, security, performance, reliability, scalability, agility, etc., which can be measurable in a quantifiable manner) of the network that can be provided to step 208 by a system administrator and/or an automated system, or by CSP network 202 itself. In one example, an operational goal includes the ability to operate at 60,000 IOPS.

Step 210 then determines any additional new device(s) using one or more first resolution trees generated with a gradient boosting algorithm (e.g., GBDT, GBRT, GBM framework).

By way of one example, once device telemetry is collected (step 206), the analysis (step 208) can be done at the component level to determine the device state and at the device level to evaluate the goal. Device state based on components can be obtained via the sensors of each BMC 205 which measure internal physical variables such as, but not limited to, temperature, humidity, power-supply voltage, fan speeds, communications parameters, and operating system (OS) functions. If any of these variables exceed respective predetermined threshold values, a recommendation can be made for a hardware device to be added/upgraded. For example, a device such as a memory card or a network interface controller (NIC) card can be recommended to be added.

If the device is part of any goal, process flow 200 gathers the state at the device level and then determines the goal state. The state of the goal, devices, and their components are used as input to a gradient boosting algorithm (step 210) which can comprise a trainable machine learning (ML) model that provides a recommendation based on a resolution (decision) tree methodology.

In one example, as mentioned above, XGBoost can be used as an effective and efficient implementation of gradient boosting that is based on regression-predictive modeling using a supervised regression model. XGBoost is an ensemble learning algorithm that minimizes a regularized objective function that combines a convex loss function (based on the difference between the predicted and target outputs) and a penalty term for model complexity (i.e., regression tree functions). One ordinarily skilled in the art will appreciate the straightforward application of XGBoost or the like to a device provisioning use case presented in accordance with illustrative embodiment. By way of example only, further details of the XGBoost algorithm can be found in the technical literature such as T. Chen et al., XGBoost: A Scalable Tree Boosting System, Proceedings of the 22nd ACM SIGKDD International Conference on Knowledge Discovery and Data Mining, August 2016, the disclosure of which is incorporated by reference herein in its entirety.

In some illustrative embodiments, the resolution tree is trained using features such as, but not limited to: memory consumption; total memory slots; memory slots which are filled; a memory model; extreme memory profiles (XMP) mode for memory; memory configuration; supported memory configurations; part of cluster; total central processing unit (CPU) slots; CPU cores which are filled; CPU model; supported CPU models; overclocking of CPU mode; NIC card slots; NIC configuration; integrated Dell remote access controller (iDRAC) version; iDRAC express; iDRAC license available; supported iDRAC modes; supported iDRAC versions; total fan slots; fan slots occupied; fan revolutions per minute (RPM); supported fan RPM; hard disk drive (HDD) model; HDD configuration; supported HDD configuration; total peripheral component interconnect (PCI) slots; PCI slots which are filled; and/or supported PCI cards and their versions.

Thus, in this analysis example, each component and its firmware configuration settings are the features provided as input to the ML model after performing one or more preprocessing operations comprising: performing one-hot encoding (i.e., a technique used to represent categorical variables as numerical values in an ML model); representing categorical variables as binary vectors; for text data, representing each word including symbols as vectors (e.g., Word2Vec); and/or normalization (standard).

In some illustrative embodiments, ML model training can be performed in two phases:
(i) Phase 1: a generic training where the input is provided to the model wherein the model provides the importance of features; and
(ii) Phase 2: less important features are removed from the input set, and then perform parameter tuning such as providing optimal values for learning rate and minimal split, etc.

After phase 2, the model is trained, and the model can be saved as an .h5 file in some illustrative embodiments.

The trained model (.h5 file) is then used in step 210 to predict for a new data set. The output which may be in one-hot encoding format is reversed to obtain the exact recommendation text.

In step 212, the newly recommended device (e.g., server or server component) is dispatched to an IT administrator.

In step 214, the new device is deployed on CSP network 202.

Step 216 determines driver and configuration settings for new device(s) using one or more second resolution trees (different than the one or more first resolution trees of step 210) associated with the gradient boosting algorithm (e.g., GBDT/GBRT or GBM framework using one or more trainable ML models) as explained above.

Step 218 then dynamically recommends creation of a new hardware profile or selection of an existing hardware profile for each new device. For example, once the hardware is added or a component is placed inside the device, process flow 200 determines the driver and configuration settings based on network details such as, by way of example: configuration (e.g., memory, CPU, connected components); component model; non-vulnerable and compatible driver; certified driver; environment factors (e.g., network speed, non-production, or production grade); how much bandwidth and compute capacity are required to support additional requirements and improve the efficiency of the network/device; and/or available hardware profile templates.

In one non-limiting GBDT implementation, the above details are decomposed into an XGBoost regression tree to dynamically identify an existing hardware profile or to create a new hardware profile with the required configuration. Using the dynamically created hardware profile template, bare metal servers are configured. For example, in an environment where a physical device orchestrator (e.g., Bare Metal Orchestrator) is monitoring and configuring CSP network 202 and the new device is added, the hardware profile template is selected based on the above factors.

Step 220 deploys the one or more recommended hardware profiles from step 218 to the corresponding one or more new devices enabling the new devices to operate with the existing devices 204 on CSP network 202 to achieve the overall goal.

The following are some non-limiting examples of recommendations generated by and caused to be implemented by machine learning-based device provisioning manager 110 and process flow 200.

### Example 1

Issue: Bare metal servers are reaching the peak limit in the stack.

Recommendation: Adding a new server, which is of the same model and configuration as the other servers in the cluster. Since the cluster behind the servers should be of the same configuration, the server that is dispatched will be of the same configuration.

Based on the recommendation and the warranty of the device or license of the solution, the respective hardware/component is dispatched to the IT administrator. Once the new device is deployed on the network, when the server is added with iDRAC and dynamic host configuration protocol (DHCP) enabled, it does automatic discovery, identifies the addition of the hardware, and consumes the same for growing the stack based on the need (goal).

### Example 2

Issue: The memory is reaching 100%, and one of the slots in all the cluster servers is empty.

Recommendation: Based on this factor, since the memory was added, the memory dispatch will happen for all the cluster servers. Since the cluster behind the servers should be of the same configuration, the memory required for all the servers in the cluster is dispatched.

Advantageously, as compared to existing approaches, machine learning-based device provisioning manager 110 and process flow 200 are intelligently using hardware and OS metrics to understand the need of expanding a network by adding the new devices. Further, machine learning-based device provisioning manager 110 and process flow 200 understand the context of the network in terms of its operational, performance, and health status in order to recommend to the administrator the improvements that are required in terms of add-on hardware. Still further, using machine learning-based device provisioning manager 110 and process flow 200 to understand the context of the network with various complex hardware sets, hardware profile templates can be dynamically recommended with required settings based on the nature of the device and its usability (e.g., is it used as part of a solution or as a standalone) and customer environment workload (e.g., telco environment).

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

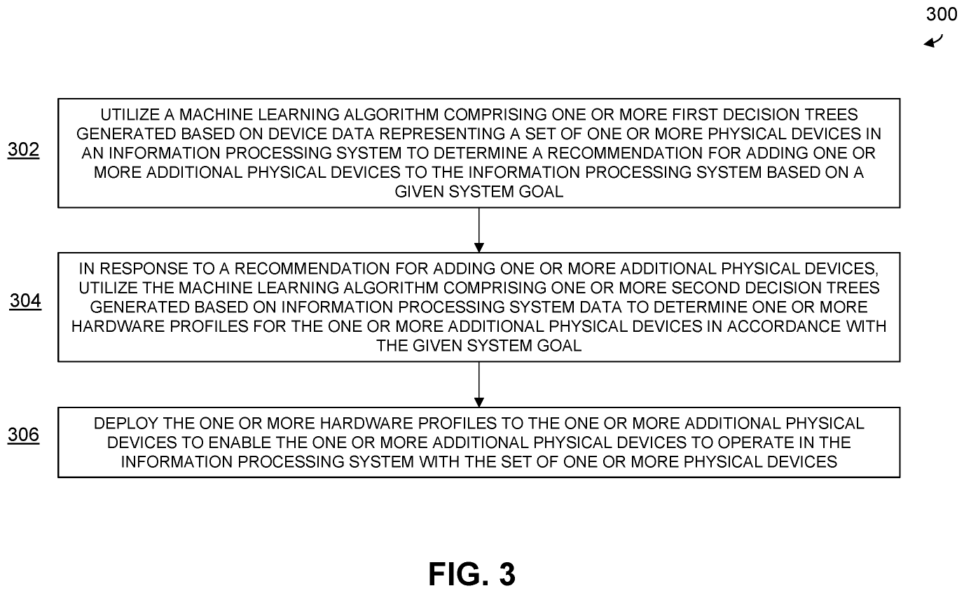

FIG. 3 illustrates a device provisioning management methodology 300 according to an illustrative embodiment. Step 302 utilizes a machine learning algorithm comprising one or more first decision trees generated based on device data representing a set of one or more physical devices in an information processing system to determine a recommendation for adding one or more additional physical devices to the information processing system based on a given system goal. Step 304, in response to a recommendation for adding one or more additional physical devices, utilizes the machine learning algorithm comprising one or more second decision trees generated based on information processing system data to determine one or more hardware profiles for the one or more additional physical devices in accordance with the given system goal. Step 306 deploys the one or more hardware profiles to the one or more additional physical devices to enable the one or more additional physical devices to operate in the information processing system with the set of one or more physical devices.

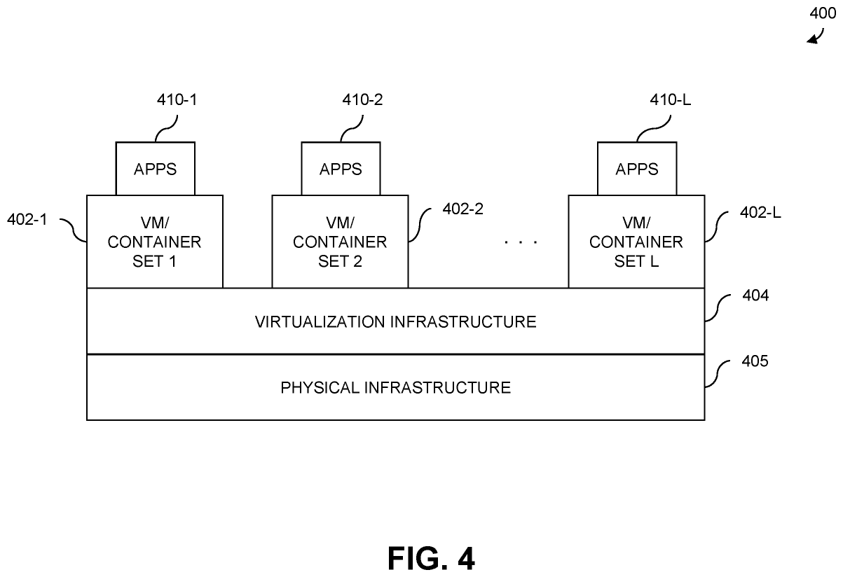

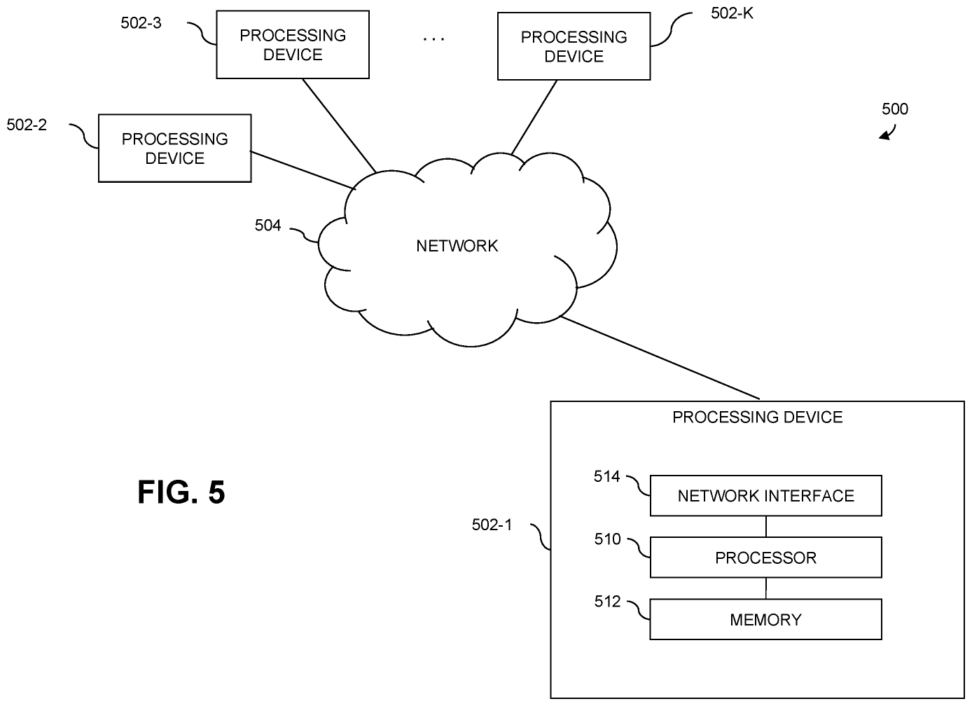

Illustrative embodiments of processing platforms utilized to implement functionality for application program management using an application assistant will now be described in greater detail with reference to FIGS. 4 and 5. Although described in the context of information processing system environments mentioned herein, these platforms may also be used to implement at least portions of other information processing systems in other embodiments.

FIG. 4 shows an example processing platform comprising infrastructure 400. Infrastructure 400 comprises a combination of physical and virtual processing resources that may be utilized to implement at least a portion of the information processing system environment 100 in FIG. 1. Infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

Infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. A hypervisor platform may be used to implement a hypervisor within the virtualization infrastructure 404, where the hypervisor platform has an associated virtual infrastructure management system. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system environments mentioned herein may each run on a computer, server, storage device or other processing platform element. A given such element may be viewed as an example of what is more generally referred to herein as a “processing device.” Infrastructure 400 shown in FIG. 4 may represent at least a portion of one processing platform. Another example of such a processing platform is processing platform 500 shown in FIG. 5.

The processing platform 500 in this embodiment comprises at least a portion of information processing system environment 100 and includes a plurality of processing devices, denoted 502-1, 502-2, 502-3, . . . 502-K, which communicate with one another over a network 504.

The network 504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 512 may comprise random access memory (RAM), read-only memory (ROM), flash memory or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and information processing system environments mentioned herein may include additional or alternative processing platforms, as well as numerous distinct processing platforms in any combination, with each such platform comprising one or more computers, servers, storage devices or other processing devices. For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for application monitoring with predictive anomaly detection and fault isolation as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, edge computing environments, applications, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing platform comprising at least one processor coupled to at least one memory, wherein the at least one processing platform is configured to:
utilize a machine learning algorithm comprising one or more first decision trees generated based on device data representing a set of one or more physical devices in an information processing system to determine a recommendation for adding one or more additional physical devices to the information processing system based on a given system goal;
in response to a recommendation for adding one or more additional physical devices, utilize the machine learning algorithm comprising one or more second decision trees generated based on information processing system data to determine one or more hardware profiles for the one or more additional physical devices in accordance with the given system goal; and
deploy the one or more hardware profiles to the one or more additional physical devices to enable the one or more additional physical devices to operate in the information processing system with the set of one or more physical devices.

2. The apparatus of claim 1, wherein the machine learning algorithm comprises a gradient boosting algorithm.

3. The apparatus of claim 2, wherein, in the utilization of the machine learning algorithm comprising the one or more first decision trees, the gradient boosting algorithm utilizes one or more machine learning models trained on at least a portion of the device data.

4. The apparatus of claim 2, wherein, in the utilization of the machine learning algorithm comprising the one or more second decision trees, the gradient boosting algorithm utilizes one or more machine learning models trained on at least a portion of the information processing system data.

5. The apparatus of claim 1, wherein the device data is collected via a physical device orchestration platform operatively coupled between the set of physical devices and the apparatus.

6. The apparatus of claim 1, wherein the device data for each of the set of physical devices comprises data indicative of at least one of: one or more memory features; one or more processor features; one or more network interface features; one or more remote access features; one or more storage component features; one or more peripheral interface features; and one or more device environmental features.

7. The apparatus of claim 1, wherein the information processing system comprises data indicative of at least one of: one or more system configuration features; one or more driver features;
one or more system environmental features; one or more system bandwidth features; and one or more hardware profile features.

8. The apparatus of claim 1, wherein the given system goal comprises at least one of an efficiency goal, a security goal, a performance goal, a reliability goal, a scalability goal, and an agility goal.

9. The apparatus of claim 1, wherein the set of one or more physical devices comprises at least one of one or more bare metal servers, one or more components of a bare metal server, and combinations thereof.

10. The apparatus of claim 1, wherein the information processing system comprises a communication service provider network.

11. A computer program product comprising a non-transitory processor-readable storage medium having stored therein program code of one or more software programs, wherein the program code when executed by at least one processing device causes the at least one processing device to:
utilize a machine learning algorithm comprising one or more first decision trees generated based on device data representing a set of one or more physical devices in an information processing system to determine a recommendation for adding one or more additional physical devices to the information processing system based on a given system goal;
in response to a recommendation for adding one or more additional physical devices, utilize the machine learning algorithm comprising one or more second decision trees generated based on information processing system data to determine one or more hardware profiles for the one or more additional physical devices in accordance with the given system goal; and
deploy the one or more hardware profiles to the one or more additional physical devices to enable the one or more additional physical devices to operate in the information processing system with the set of one or more physical devices.

12. The computer program product of claim 11, wherein the machine learning algorithm comprises a gradient boosting algorithm.

13. The computer program product of claim 12, wherein, in the utilization of the machine learning algorithm comprising the one or more first decision trees, the gradient boosting algorithm utilizes one or more machine learning models trained on at least a portion of the device data.

14. The computer program product of claim 12, wherein, in the utilization of the machine learning algorithm comprising the one or more second decision trees, the gradient boosting algorithm utilizes one or more machine learning models trained on at least a portion of the information processing system data.

15. The computer program product of claim 11, wherein the set of one or more physical devices comprises at least one of one or more bare metal servers, one or more components of a bare metal server, and combinations thereof.

16. The computer program product of claim 11, wherein the information processing system comprises a communication service provider network.

17. A method comprising:
utilizing a machine learning algorithm comprising one or more first decision trees generated based on device data representing a set of one or more physical devices in an information processing system to determine a recommendation for adding one or more additional physical devices to the information processing system based on a given system goal;
in response to a recommendation for adding one or more additional physical devices, utilizing the machine learning algorithm comprising one or more second decision trees generated based on information processing system data to determine one or more hardware profiles for the one or more additional physical devices in accordance with the given system goal; and
deploying the one or more hardware profiles to the one or more additional physical devices to enable the one or more additional physical devices to operate in the information processing system with the set of one or more physical devices;
wherein the steps are performed in accordance with a processing device comprising a processor operatively coupled to a memory and configured to execute program code.

18. The method of claim 17, wherein the machine learning algorithm comprises a gradient boosting algorithm.

19. The method of claim 18, wherein, in the utilization of the machine learning algorithm comprising the one or more first decision trees, the gradient boosting algorithm utilizes one or more machine learning models trained on at least a portion of the device data.

20. The method of claim 18, wherein, in the utilization of the machine learning algorithm comprising the one or more second decision trees, the gradient boosting algorithm utilizes one or more machine learning models trained on at least a portion of the information processing system data.
